(19) United States
(12) Patent Application Publication
(10) Pub. No.: US 2025/0329282 A1
(43) Pub. Date: Oct. 23, 2025

(54) DISPLAY PANEL, DRIVING METHOD THEREOF, AND DISPLAY DEVICE

(71) Applicant: Tianma Advanced Display Technology Institute (Xiamen) Co., Ltd., Xiamen (CN)

(72) Inventors: Yingteng ZHAI, Xiamen (CN); Feng QIN, Xiamen (CN); Xuhui PENG, Xiamen (CN)

(73) Assignee: Tianma Advanced Display Technology Institute (Xiamen) Co., Ltd., Xiamen, FJ (CN)

(21) Appl. No.: 19/256,726

(22) Filed: Jul. 1, 2025

(30) Foreign Application Priority Data
Oct. 30, 2024 (CN) 202411524174.8

(51) Int. Cl. G09G 3/20

(52) U.S. Cl. CPC G09G 3/2074; G09G 2300/026; G09G 2310/08; G09G 2320/0233; G09G 2330/021

(57) ABSTRACT

Provided are a display panel, a driving method thereof, and a display device, which relate to the field of display technology, for improving the brightness consistency of the display panel. The display panel includes sub-pixels having different states. The different states include different light emitting intensities of the sub-pixels, or different first data signals received by the sub-pixels; or different first power signals received by the sub-pixels. Said “the sub-pixels having different states” includes following cases: a same one of the sub-pixels corresponds to different states in different periods, or the sub-pixels in at least two different regions have different states.

### CROSS-REFERENCE TO RELATED APPLICATIONS

The present application claims priority to Chinese Patent Application No. 202411524174.8, filed on Oct. 30, 2024, the content of which is incorporated herein by reference in its entirety.

### TECHNICAL FIELD

The present disclosure relates to the field of display technology, and in particular, to a display panel, a driving method thereof, and a display device.

### BACKGROUND

With continuous development of science and technology, more and more display devices are widely used in people's daily life and work, and become an indispensable and important tool for people today. Moreover, with the continuous development of display technology, the requirements of consumers for displayers have been continuously increased, and various types of displayers are emerging endlessly, such as organic light emitting diode (OLED), mini light emitting diode (Mini LED), and micro light emitting diode (Micro LED).

Currently, the display panel has a problem of display non-uniformity (Mura).

### SUMMARY

In view of this, the present disclosure provides a display panel, a driving method thereof, and a display device, to improve display uniformity of the display panel.

In an aspect, an embodiment of the present disclosure provides a display panel including sub-pixels having different states. The different states include different light emitting intensities of the sub-pixels, or different first data signals received by the sub-pixels, or different first power signals received by the sub-pixels. Said “the sub-pixels having different states” includes following cases: a same one of the sub-pixels corresponds to different states in different periods, or the sub-pixels in at least two different regions have different states.

In another aspect, an embodiment of the present disclosure provides a display device including a display panel, which includes sub-pixels having different states. The different states include different light emitting intensities of the sub-pixels, or different first data signals received by the sub-pixels, or different first power signals received by the sub-pixels. Said “the sub-pixels having different states” includes following cases: a same one of the sub-pixels corresponds to different states in different periods, or the sub-pixels in at least two different regions have different states.

In another aspect, an embodiment of the present disclosure provides a driving method of a display panel, which includes sub-pixels having different states. The different states include different light emitting intensities of the sub-pixels, or different first data signals received by the sub-pixels, or different first power signals received by the sub-pixels. Said “the sub-pixels having different states” includes following cases: a same one of the sub-pixels corresponds to different states in different periods, or the sub-pixels in at least two different regions have different states. The driving method includes: controlling the sub-pixels to have different states.

According to the display panel, the driving method thereof, and the display device provided by the embodiments of the present disclosure, the sub-pixels have different states, that is, the light emitting intensities of the sub-pixels are different or the first data signals received by the sub-pixels are different, or the first power signals received by the sub-pixels are different, so that a brightness difference caused by factors such as different light emitting moments of the sub-pixels or different threshold voltage drifts can be compensated, thereby improving the display consistency of the display panel in the different states.

### BRIEF DESCRIPTION OF DRAWINGS

In order to more clearly illustrate the technical solutions in the embodiments of the present disclosure, the drawings, which are intended to be used in the description of the embodiments, are briefly described as below. It will be apparent that other drawings described below are merely some embodiments of the present disclosure, and other drawings may be obtained by those skilled in the art according to these drawings.

FIG. 1 is a circuit diagram of a sub-pixel according to an embodiment of the present disclosure;

FIG. 2 is a circuit diagram of another sub-pixel according to an embodiment of the present disclosure;

FIG. 3 is a circuit diagram of yet another sub-pixel according to an embodiment of the present disclosure;

FIG. 4 is an operation timing diagram of a pixel driving circuit shown in FIG. 3;

FIG. 5 is another operation timing diagram of a pixel driving circuit shown in FIG. 3;

FIG. 6 is yet another operation timing diagram of a pixel driving circuit shown in FIG. 3;

FIG. 7 is an operation timing diagram of a sub-pixel in two frame periods according to an embodiment of the present disclosure;

FIG. 8 is an operation timing diagram of two different sub-pixels according to an embodiment of the present disclosure;

FIG. 9 is a schematic diagram of a display panel according to an embodiment of the present disclosure;

FIG. 10 is a schematic diagram of a display portion according to an embodiment of the present disclosure;

FIG. 11 is a schematic diagram of another display panel according to an embodiment of the present disclosure;

FIG. 12 is an operation timing diagram of a display panel according to an embodiment of the present disclosure;

FIG. 13 is a schematic diagram of another display panel according to an embodiment of the present disclosure;

FIG. 14 is a schematic diagram of yet another display panel according to an embodiment of the present disclosure;

FIG. 15 is a schematic diagram of yet another display panel according to an embodiment of the present disclosure; and

FIG. 16 is a schematic diagram of a display device according to an embodiment of the present disclosure.

### DESCRIPTION OF EMBODIMENTS

In order to better understand the technical solutions of the present disclosure, embodiments of the present disclosure are described in detail as follows with reference to the drawings.

It should be noted that, the described embodiments are merely some of, rather than all of the embodiments of the present disclosure. All other embodiments obtained by those skilled in the art according to the embodiments of the present disclosure shall fall within a scope of the present disclosure.

The terms used in the embodiments of the present disclosure are only for the purpose of describing specific embodiments, and are not intended to limit the present disclosure. Unless otherwise noted in the context, the singular form expressions “a”, “an”, “the”, and “said” used in the embodiments and appended claims of the present disclosure are also intended to represent plural form expressions thereof.

It should be understood that the term “and/or” used herein is merely an association relationship describing an associated object, and indicates that there may be three relationships, for example, A and/or B, and may indicate: only A, both A and B, and only B. In addition, the character “/” herein generally means an “or” relationship between the associated objects.

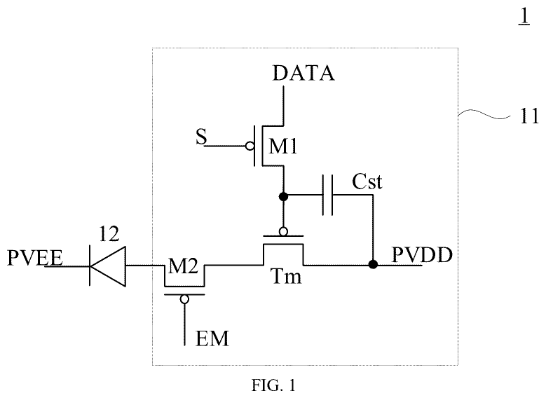

An embodiment of the present disclosure provides a display panel including sub-pixels, as shown in FIG. 1, which is a circuit diagram of a sub-pixel according to an embodiment of the present disclosure. The sub-pixel 1 includes a pixel driving circuit 11 and a light emitting element 12 that are electrically connected to each other. Exemplarily, the light emitting element 12 can be a light emitting diode (LED) that includes a mini light emitting diode (mini LED), a micro light emitting diode (Micro LED), or an organic light emitting diode (OLED), which may be configured according to actual situations during specific implementation.

As shown in FIG. 1, the pixel driving circuit 11 at least includes a driving transistor Tm. The driving transistor Tm is configured to output a driving current according to signals applied to a gate and a first terminal of the driving transistor Tm, and the light emitting element 12 lights up under an action of the driving current. A process of the pixel driving circuit 11 driving the light emitting element 12 to emit light is a process of controlling the light emitting element 12 to emit light within an effective light emitting duration with a specific driving current within a period of one image display (i.e., one frame time duration). The brightness of the light emitting element 12 is related to the light emitting intensity and the effective light emitting duration of the light emitting element 12. The light emitting intensity of the light emitting element 12 is related to the driving current.

In an embodiment of the present disclosure, the sub-pixels 1 have different states. Exemplarily, the sub-pixels 1 having different states may be the following situation: a same sub-pixel 1 has different states at different periods, and the different periods include different frame periods, for example, a frame period corresponding to a sub-pixel is a data refresh period; alternatively, in a case that a frame period includes a plurality of sub-frames, the above-mentioned different periods may be different sub-frames within a frame period. Alternatively, the sub-pixels 1 having different states may be the following situation: the sub-pixels 1 in at least two different regions of the display panel have different states, and the different regions refer to sub-pixels located at different positions of the display panel.

According to an embodiment of the present disclosure, in an optional implementation, the different states include different light emitting intensities. The above-mentioned sub-pixels having different states means that the sub-pixels have different light emitting intensities. In an embodiment of the present disclosure, the light emitting intensity of the sub-pixel 1 is the light emitting intensity of the light emitting element 12. The light emitting intensity of the sub-pixel 1 may be an instantaneous light emitting intensity of the sub-pixel 1, and the instantaneous light emitting intensity refers to a light emitting intensity of the sub-pixel 1 at a lighting up moment. Alternatively, it may refer to a light emitting intensity of the light emitting element 12 at a certain moment or time point in a middle period of a light emitting phase. The instantaneous light emitting intensity of the sub-pixel 1 is related to the driving current that drives the sub-pixel 1 to emit light. The greater the driving current, the greater the current density, and the greater the instantaneous light emitting intensity. The instantaneous light emitting intensity of the sub-pixel 1 may generally be determined by detecting its light emitting brightness in microsecond level time. The brightness of the sub-pixel 1 in a display period (such as a frame) is related to the instantaneous light emitting intensity and the effective light emitting duration. The greater the instantaneous light emitting intensity or the longer the effective light emitting duration, the greater the brightness of the sub-pixel 1 in a display period.

Alternatively, the different states described in an embodiment of the present disclosure include different first data signals. In this case, the sub-pixels 1 having different states means that the sub-pixels 1 receive different first data signals. The first data signal can affect the driving current of the sub-pixel.

Alternatively, the different states described in an embodiment of the present disclosure include different first power signals. In this case, the sub-pixels 1 having different states means that the sub-pixels 1 receive different first power signals. The first power signal can affect the driving current of the sub-pixel.

For example, the different states include a first state and a second state that are different from each other. In an embodiment of the present disclosure, the sub-pixels 1 having different states includes the following case: a same sub-pixel 1 corresponds to the first state and the second state, respectively, in different periods. For example, the sub-pixel 1 has the first state in a first period and the second state in a second period. Alternatively, the display panel includes sub-pixels 1 disposed in at least two different regions, and for the sub-pixels 1 in the at least two different regions, the sub-pixel 1 in a region has the first state, and the sub-pixel 1 in another region has the second state.

Exemplarily, in an embodiment of the present disclosure, the light emitting intensity of the sub-pixel 1 in the first state is different from the light emitting intensity of the sub-pixel 1 in the second state. Alternatively, the first data signal received by the sub-pixel 1 in the first state is different from the first data signal received by the sub-pixel 1 in the second state, or the first power signal received by the sub-pixel 1 in the first state is different from the first power signal received by the sub-pixel 1 in the second state.

In an embodiment of the present disclosure, when configuring the pixel driving circuit 11, in an optional implementation, as shown in FIG. 1, the pixel driving circuit 11 at least includes a driving transistor Tm, a data writing transistor M1, a light emitting control transistor M2, and a storage capacitor Cst. In a frame period, an operation process of the pixel driving circuit 11 includes a data writing phase and a light emitting phase. In the data writing phase, the data writing transistor Ml is turned on under the control of the scanning signal S to write the first data signal DATA into the gate of the driving transistor Tm. In the light emitting phase, the light emitting control transistor M2 is turned on under the control of the light emitting control signal EM, and the driving transistor Tm generates the driving current under the control of a gate voltage thereof, and the driving current is provided to the light emitting element 12 of the light emitting device.

It is also necessary to configure a first power signal PVDD and a second power signal PVEE to drive the light emitting element 12 to emit light. For example, the first power signal PVDD is a positive power voltage, and the second power signal PVEE is a negative power voltage. In an embodiment of the present disclosure, the driving current Id flowing through the light emitting element 12 satisfies: Id=K1(Vgs−Vth)², where K1 represents a constant related to a characteristic of the driving transistor Tm, Vgs represents a gate-source voltage difference of the driving transistor Tm, and Vth represents a threshold voltage of the driving transistor Tm. In an embodiment of the present disclosure, as shown in FIG. 1, the gate of the driving transistor Tm is electrically connected to a first data signal line DATA, and a first electrode of the driving transistor Tm is electrically connected to a first power signal line PVDD. That is, the first data signal DATA and the first power signal PVDD affect the driving current Id generated by the driving transistor Tm, thereby affecting the brightness of the light emitting element 12. In an embodiment of the present disclosure, the magnitude of the driving current Id can be adjusted by adjusting the first data signal DATA or the first power signal PVDD, thereby adjusting the light emitting intensity of the light emitting element 12.

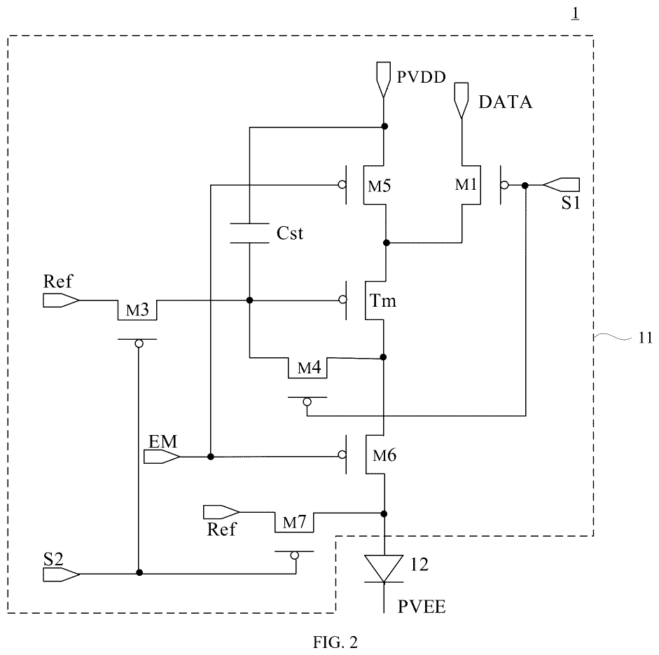

In another optional implementation, as shown in FIG. 2, which is a circuit diagram of another sub-pixel according to an embodiment of the present disclosure, the pixel driving circuit 11 includes a driving transistor Tm, a data writing transistor M1, a gate reset transistor M3, a threshold compensation transistor M4, an electrode reset transistor M7, a first light emitting control transistor M5, a second light emitting control transistor M6, and a storage capacitor Cst.

In one frame period, the operation process of the pixel driving circuit 11 at least includes a reset phase, a data writing phase and a light emitting phase.

In the reset phase, the gate reset transistor M3 is turned on under the control of the second scanning signal S2 to write a reset signal Ref into the gate of the driving transistor Tm, and the electrode reset transistor M7 is turned on under the control of the second scanning signal S2 to write the reset signal Ref into the anode of the light emitting element 12.

In the data writing phase, the data writing transistor M1 and the threshold compensation transistor M4 are turned on under the control of the first scanning signal S1, to write the first data signal DATA into the gate of the driving transistor Tm, and to self-check and compensate the threshold voltage of the driving transistor Tm.

In the light emitting phase, the first light emitting control transistor M5 and the second light emitting control transistor M6 are turned on under the control of the light emitting control signal EM, and the driving transistor Tm generates the driving current under the control of the gate voltage thereof and the driving current is provided to the light emitting element 12. The driving current Id satisfies Id=K2(V_{DATA}−V_{PVDD})², where K2 represents a constant related to a characteristic of the driving transistor Tm, V_{DATA} represents a voltage value of the first data signal DATA, and V_{PVDD} represents a voltage value of the first power signal PVDD. In an embodiment of the present disclosure, the magnitude of driving current Id can be adjusted by adjusting the first data signal DATA or the first power signal PVDD, thereby adjusting the light emitting intensity of the light emitting element 12.

In an embodiment of the present disclosure, the sub-pixels 1 have different states, that is, the sub-pixels 1 have different light emitting intensities or receive different first data signals; or the sub-pixels 1 receive different first power signals, so that a brightness difference caused by factors such as different light emitting moments of the sub-pixels or different threshold voltage drifts can be compensated, thereby improving the display consistency of the display panel in different states.

Exemplarily, target grayscales in the above-mentioned different states are the same. That is, the above-mentioned different states refer to different states under the common reference standard under the same target grayscale. For example, different states include a first state and a second state that are different from each other, and the first state and the second state have same target grayscale. The target grayscale is related to image data received by the sub-pixel, and the target grayscale can be regarded as an ideal grayscale that the sub-pixel is expected to achieve. According to an embodiment of the present disclosure, different states have a same target grayscale, and in combination with the above-described description that the sub-pixels have different light emitting intensities, or receive different first data signals; or the sub-pixels have different first power signals, and the brightness uniformity can be improved, the actual brightness of the sub-pixels at a same target grayscale tends to be consistent, thereby improving the brightness uniformity of the display panel. The actual brightness can be detected by a brightness detection instrument, and the actual brightness refers to the brightness displayed after taking into account influence factors such as different light emitting moments or different threshold voltage drifts of the sub-pixels.

It can be understood that, the pixel driving circuit 11 shown in FIG. 1 and FIG. 2 is only schematic, and is not intended to limit the present disclosure. The pixel driving circuit 11 in the display panel provided by the present disclosure can be any circuit that can regulate the first data signal or the first power signal during the operation of the pixel driving circuit 11 to change the driving current of the pixel driving circuit 11.

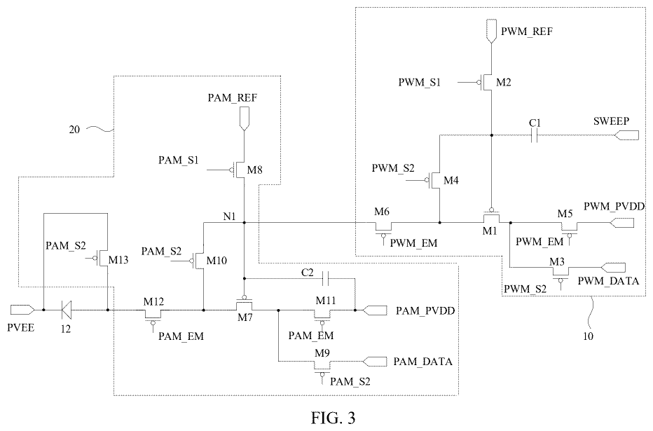

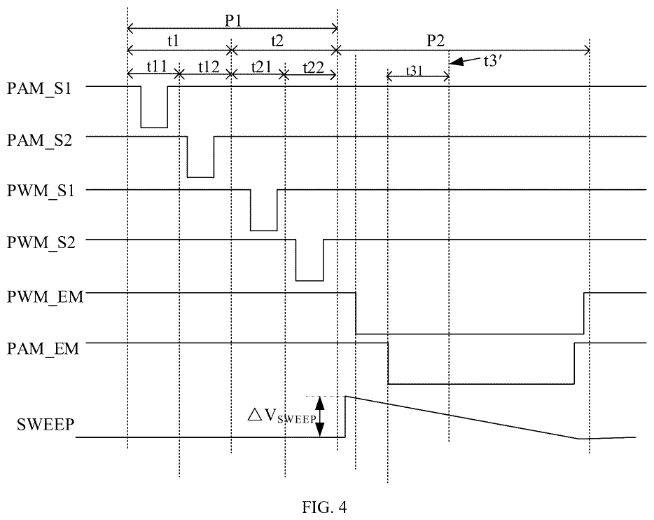

For example, as shown in FIG. 3 and FIG. 4, FIG. 3 is a circuit diagram of another sub-pixel according to an embodiment of the present disclosure, and FIG. 4 is an operation timing diagram of the pixel driving circuit shown in FIG. 3. The pixel driving circuit 11 includes a pulse width modulation (PWM) module 10 and a pulse amplitude modulation (PAM) module 20 that are electrically connected to each other, and the pulse amplitude modulation module 20 is electrically connected to the light emitting element 12.

The pixel driving circuit 11 generates a driving current with an adjustable duration under the control of the pulse amplitude modulation module 20 and the pulse width modulation module 10. The pulse amplitude modulation module 20 corresponds to a first data signal PAM_DATA, that is, the pulse amplitude modulation module 20 receives the first data signal PAM_DATA. The pulse width modulation module 10 corresponds to a second data signal PWM_DATA, that is, the pulse width modulation module 10 receives the second data signal PWM_DATA.

In an example, the pulse width modulation module 10 is configured to output a pulse width setting signal to a first terminal of the pulse amplitude modulation module 20 based on the second data signal PWM_DATA and a swept-frequency signal SWEEP, so as to control the duration of providing the driving current to the light emitting element 12. In FIG. 3, a first terminal of the pulse amplitude modulation module 20 is electrically connected to a first node N1. The pulse amplitude modulation module 20 is configured to control the magnitude of the driving current provided to the light emitting element 12 based on the first data signal PAM_DATA and a first power signal PAM_PVDD.

For example, as shown in FIG. 3, the pulse width modulation module 10 includes a first driving transistor M1, a first gate reset transistor M2, a first data writing transistor M3, a first compensation transistor M4, a first light emitting control transistor M6, a second light emitting control transistor M5, and a first capacitor C1.

The second light emitting control transistor M5 is connected between a second power signal line PWM_PVDD and a first electrode of the first driving transistor M1, and the first light emitting control transistor M6 is connected between a second electrode of the first driving transistor M1 and the first node N1. The first data writing transistor M3 is connected between a second data signal line PWM_DATA and the first electrode of the first driving transistor M1, the first compensation transistor M4 is connected to the second electrode and the gate of the first driving transistor M1, and the first gate reset transistor M2 is connected to the gate of the first driving transistor Ml and the pulse width reset signal line PWM_REF. A first electrode plate of the first capacitor C1 is connected to the gate of the first driving transistor M1, and a second electrode plate of the first capacitor C1 receives the swept-frequency signal SWEEP. A gate of the first gate reset transistor M2 receives a first pulse width scanning signal PWM_S1, and gates of the first data writing transistor M3 and the first compensation transistor M4 receive a second pulse width scanning signal PWM_S2. Gates of the first light emitting control transistor M6 and the second light emitting control transistor M5 receive a pulse width light emitting control signal PWM_EM.

The pulse amplitude modulation module 20 includes a second driving transistor M7, a second gate reset transistor M8, a second data writing transistor M9, a second compensation transistor M10, a third light emitting control transistor M11, a fourth light emitting control transistor M12, an electrode reset transistor M13, and a second capacitor C12.

The third light emitting control transistor M11 is connected between the first power signal line PAM_PVDD and a first electrode of the second driving transistor M7, and the fourth light emitting control transistor M12 is connected between a second electrode of the second driving transistor M7 and the light emitting element 12. The second driving transistor M7 is configured to generate a driving current under control of a gate voltage thereof, and a gate of the second driving transistor M7 is electrically connected to the first node N1, to receive the pulse width setting signal output by the pulse width modulation module 10. The second data writing transistor M9 is connected between the first data signal line PAM_DATA and the first electrode of the second driving transistor M7. The second compensation transistor M10 is connected to the second electrode and the gate of the second driving transistor M7, the second gate reset transistor M8 is connected to the gate of the second driving transistor M7 and a pulse amplitude reset signal line PAM_REF, the electrode reset transistor M13 is connected to the first electrode of the light emitting element 12, the fourth light emitting control transistor M12 is connected to the first electrode of the light emitting element 12, and the second electrode of the light emitting element 12 is connected to a third power signal line PVEE. A gate of the second gate reset transistor M8 receives a first pulse amplitude scanning signal PAM_S1. Gates of the second data writing transistor M9, the second compensation transistor M10, and the electrode reset transistor M13 receive a second pulse amplitude scanning signal PAM_S2. Gates of the third light emitting control transistor M11 and the fourth light emitting control transistor M12 receive a pulse amplitude light emitting control signal PAM_EM.

It should be noted that, a first electrode of the electrode reset transistor M13 shown in FIG. 3 being connected to the third power signal line PVEE is merely for illustration. In some other embodiments of the present disclosure, the first electrode of the electrode reset transistor M13 can also receive a pulse amplitude reset signal PAM_REF, that is, the first electrode of the electrode reset transistor M13 and the first electrode of the second gate reset transistor M8 receive a same signal. In some other embodiments of the present disclosure, the first electrode of the electrode reset transistor M13 is not connected to the third power signal line PVEE, and the first electrode of the electrode reset transistor M13 and the first electrode of the second gate reset transistor M8 receive different signals, which are not illustrated herein.

Exemplarily, as shown in FIG. 4, in one frame period, the operation process of the pixel driving circuit 11 includes a writing phase P1 and a light emitting phase P2. For example, the writing phase P1 can include a first writing phase t1 and a second writing phase t2. For example, a frame period corresponding to a sub-pixel is a data refresh period, that is, a period of the first writing phase t1.

In the first writing phase t1, the pulse amplitude modulation module 20 sequentially performs a first gate reset phase t11 and a first data writing phase t12.

In the first gate reset phase t11, the first pulse amplitude scanning signal PAM_S1 is at an enable level, the second gate reset transistor M8 is turned on, and the pulse amplitude reset signal PAM_REF is written into the gate of the second driving transistor M7 through the second gate reset transistor M8, to reset the gate of the second driving transistor M7.

In the first data writing phase t12, the second pulse amplitude scanning signal PAM S2 is at an enable level, the second data writing transistor M9 and the second compensation transistor M10 are turned on, the first data signal PAM_DATA is written into the gate of the second driving transistor M7 through the second data writing transistor M9 and the second compensation transistor M10, and threshold compensation is performed. For example, during this phase, the electrode reset transistor M13 is turned on to reset the electrode of the light emitting element 12.

In the second writing phase t2, the pulse width modulation module 10 sequentially performs a second gate reset phase t21 and a second data writing phase t22.

In the second gate reset phase t21, the first pulse width scanning signal PWM_S1 is at an enable level, the first gate reset transistor M2 is turned on, and the pulse width reset signal PWM_REF is written into the gate of the first driving transistor M1 through the first gate reset transistor M2, to reset the gate of the first driving transistor M1.

In the second data writing phase t22, the second pulse width scanning signal PWM_S2 is at an enable level, the first data writing transistor M3 and the first compensation transistor M4 are turned on, and the second data signal PWM_DATA is written into the gate of the first driving transistor M1 through the turned on first data writing transistor M3 and first compensation transistor M4, and threshold compensation is performed.

Then, the light emitting phase P2 is entered. In the light emitting phase P2, the pulse width modulation module 10 generates a pulse width setting signal based on the second data signal PWM_DATA and the swept-frequency signal SWEEP, so as to control the time for the pulse amplitude modulation module 20 to provide the driving current, thereby adjusting the effective light emitting duration of the light emitting element 12, and thus further controlling the light emitting brightness of the light emitting element 12. The driving current Id is calculated by Id=K3(V_{PAM_DATA}−V_{PAM_PVDD})², where V_{PAM_DATA} represents a voltage value of the first data signal PAM_DATA, V_{PAM_PVDD} represents a voltage value of the first power signal PAM_PVDD, and K3 represents a constant related to a characteristic of the second driving transistor M7.

It should be noted that, the light emitting phase P2 is not a phase in which the light emitting element 12 effectively emits light, and the light emitting phase P2 includes an effective light emitting period and a non-light emitting period, that is, a duration of the effective light emitting period is shorter than a duration of the light emitting phase P2. The light emitting phase P2 can be understood as a phase in which the pulse amplitude light emitting control signal PAM_EM and the pulse width light emitting control signal PWM_EM are at an enable level. In the light emitting phase P2, the pulse amplitude light emitting control signal PAM_EM controls the third light emitting control transistor M11 and the fourth light emitting control transistor M12 to be turned on, and the second driving transistor M7 generates a driving current under the control of the gate voltage thereof, then the pulse amplitude modulation module 20 provides a driving current to the light emitting element 12. The pulse width light emitting control signal PWM_EM controls the first light emitting control transistor M6 and the second light emitting control transistor M5 to be turned on. The phase in which the pulse amplitude light emitting control signal PAM_EM and the pulse width light emitting control signal PWM_EM are at an enable level includes a signal change period, during which the swept-frequency signal SWEEP is a ramp signal that gradually changes from a high level to a low level. When the swept-frequency signal SWEEP changes, the voltage of the gate of the first driving transistor M1 starts to change from an initial gate voltage due to the coupling effect of the first capacitor C1, where the initial gate voltage is the voltage of the gate of the first driving transistor M1 at an initial moment of a signal change period, and the initial gate voltage is related to the second data signal PWM_DATA. When the gate voltage of the first driving transistor M1 changes to a critical voltage Vg′, and the Vg′ is calculated by Vg′=Vs−|Vth|, where Vs represents a source voltage of the first driving transistor M1, and Vs=V_{PWM_PVDD}. The first driving transistor MI changes from an off state to an on state, and the pulse width modulation module 10 gradually raises a potential of the first node N1. Finally, the first driving transistor M1 is turned on and the second power signal PWM_PVDD is sent to the first node NI through the first light emitting control transistor M6. As a result, the gate voltage of the second driving transistor M7 is changed, so that the second driving transistor M7 is turned off, thereby stopping providing the driving current to the light emitting element 12. According to different second data signals PWM_DATA, the first driving transistor M1 has different initial gate voltages, accordingly, the time required for the gate voltage of the first driving transistor M1 to change to the critical voltage Vg′ is different, that is, the time when the first driving transistor M1 is in an off state correspondingly changes.

In FIG. 4, the time point t3′ is a time point at which the second driving transistor M7 is turned off, then the time period between the start time of an effective pulse of the pulse amplitude light emitting control signal PAM_EM and the time point t3′ is an effective light emitting period t31 of the light emitting element 12.

It can be known from the above description of the operation process of the pixel driving circuit 11 that, according to the embodiments of the present disclosure, the effective light emitting duration of the light emitting element 12 can be adjusted by adjusting the second data signal PWM_DATA and the swept-frequency signal SWEEP, and the magnitude of the driving current provided by the pixel driving circuit 11 to the light emitting element 12 can be adjusted by adjusting the first data signal PAM_DATA and the first power signal PAM_PVDD.

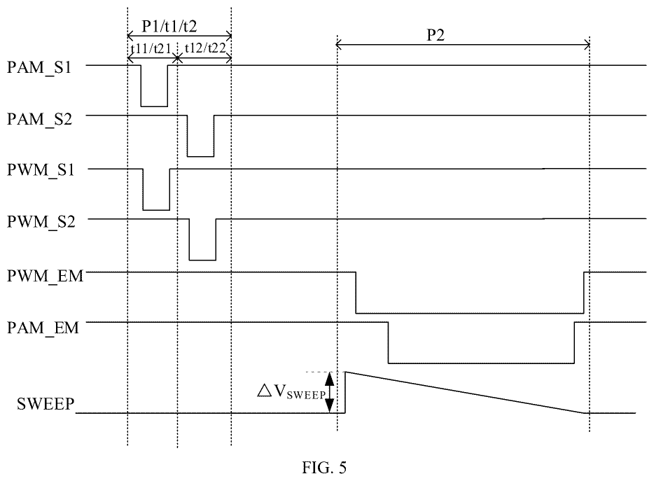

In an example, an embodiment of the present disclosure further provides another timing diagram, which can be used to drive the pixel driving circuit provided by an embodiment of FIG. 3, as shown in FIG. 5, which is another operation timing diagram of the pixel driving circuit shown in FIG. 3. The operation process of the pixel driving circuit 11 includes a writing phase P1 and a light emitting phase P2. The writing phase P1 can include a first writing phase t1 and a second writing phase t2. The first writing phase t1 includes a first gate reset phase t11 and a first data writing phase t12, and the second writing phase t2 includes a second gate reset phase t21 and a second data writing phase t22. The first gate reset phase t11 and the second gate reset phase t21 at least partially overlap each other, and the first data writing phase t12 and the second data writing phase t22 at least partially overlap each other.

Exemplarily, as shown in FIG. 4 and FIG. 5, at least in the second data writing phase t22, that is, at least in the period of providing an enable signal to the second pulse width scanning signal PWM_S2, the swept-frequency signal SWEEP is at a low level. After the enable signal period of the second pulse width scanning signal PWM_S2 ends, the swept-frequency signal SWEEP jumps from a low level to a high level, and a voltage value variation is ΔV_{SWEEP}. In the light emitting phase P2, the swept-frequency signal SWEEP is a ramp signal that gradually changes from a high level to a low level. Since the swept-frequency signal line SWEEP is connected to the gate of the first driving transistor M1 through the first capacitor C1, a gate potential of the first driving transistor M1 is raised in the process that the swept-frequency signal SWEEP jumps from a low level to a high level, and an gate voltage of the first driving transistor M1 is increased by ΔV_{SWEEP} after writing the second data signal PWM_DATA and performing the threshold compensation. That is, the initial gate voltage Vg1 is calculated by Vg1=V_{PWM_DATA}−|Vth|+ΔV_{SWEEP}, where V_{PWM_DATA} represents a voltage value of the second data signal PWM_DATA, and Vth represents a threshold voltage of the first driving transistor M1.

When the critical voltage Vg′ of the first driving transistor M1 remains unchanged, the swept-frequency signal SWEEP can reduce the voltage value of the second data signal PWM_DATA that is required by adopting the timing shown in FIG. 4. In other words, when the voltage value of the second data signal PWM_DATA remains unchanged, after data is written, the gate voltage of the first driving transistor M1 is increased due to a signal jump of the swept-frequency signal SWEEP, and when the level of the swept-frequency signal SWEEP gradually changes at a fixed rate, longer time can be provided for the gate potential of the first driving transistor M1 to drop from the initial gate voltage to the critical voltage Vg′. That is, in the light emitting phase P2, the time when the first driving transistor M1 is in an off state may become longer, and correspondingly, the time when the pulse amplitude modulation module 20 provides the driving current to the light emitting element 12 may become longer. Therefore, according to this embodiment of the present disclosure, a waveform design of the swept-frequency signal SWEEP can improve a degree of freedom in regulating the flowing period of the driving current.

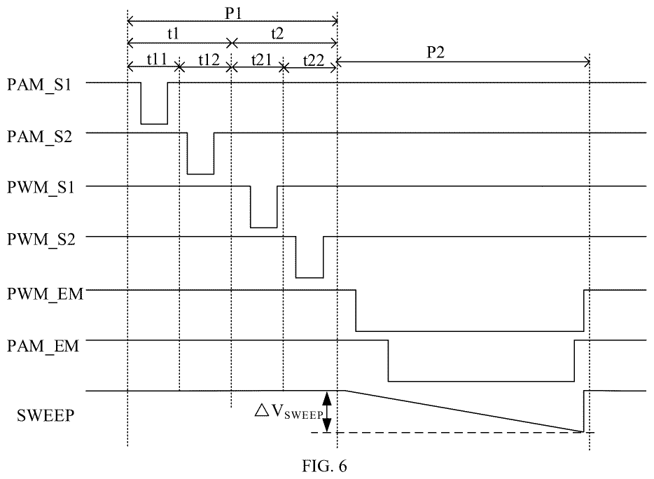

In another embodiment of the present disclosure, as shown in FIG. 6, which is yet another operation timing diagram of the pixel driving circuit shown in FIG. 3. According to an embodiment of the present disclosure, at the initial time period of the writing phase P1 and of the light emitting phase P2, the swept-frequency signal SWEEP can be at a high level; and in the light emitting phase P2, the swept-frequency signal SWEEP gradually changes from a high level to a low level, and the voltage value variation is ΔV_{SWEEP}. In this case, the initial gate voltage Vg1 is calculated by Vg1=V_{PWM_DATA}−|Vth|.

In the embodiments of the present disclosure, in the different states, the sub-pixels 1 have different first data signals PAM_DATA. For example, in an embodiment of the present disclosure, for a same sub-pixel, the sub-pixel can receive different first data signals PAM_DATA in different periods, so that the sub-pixel operates in different states in different periods. Alternatively, in an embodiment of the present disclosure, sub-pixels in different regions can receive different first data signals PAM_DATA, so that the sub-pixels in the two regions operate in different states.

Based on such a configuration, the brightness uniformity of the sub-pixels 1 in different states can be improved by differently configuring the first data signals PAM_DATA.

Exemplarily, the above-mentioned different first data signals PAM_DATA can allow the sub-pixels 1 to be driven with a greater current density in different states, thereby reducing the possibility of color deviation of the light emitting element 12.

In an optional implementation, the second data signals PWM_DATA corresponding to the sub-pixels are the same in different states. Exemplarily, the second data signal PWM_DATA may correspond to the target grayscale of the sub-pixel 1 in the current frame period.

For example, in an embodiment of the present disclosure, for a same sub-pixel, the sub-pixel can receive a same second data signal PWM_DATA at different periods, in cooperation with the above-mentioned manner of making the sub-pixel receive different first data signals PAM_DATA at different periods, so that the sub-pixel 1 can operate in the different states in different periods, thereby improving the brightness consistency of the display panel. Moreover, by adopting such a configuration, the driving mode of the second data signal PWM_DATA can be simplified.

Alternatively, in an embodiment of the present disclosure, the second data signals PWM_DATA corresponding to the sub-pixels 1 in different regions may be the same, in cooperation with the above-mentioned manner of making the sub-pixels 1 in different regions receive different first data signals PAM_DATA, so that the sub-pixels 1 in different regions can operate in different states, thereby improving the brightness consistency of the display panel. Moreover, by adopting such a configuration, the driving mode of the second data signal PWM_DATA can be simplified.

It should be noted that, structures of the transistors in the pixel driving circuit shown in FIG. 3 are merely for illustration. Types of the transistors in the pixel driving circuit are not limited in the embodiments of the present disclosure, and can be configured by those skilled in the art according to actual situations. Exemplarily, a conductivity type of the transistor may be N-type or P-type, a structure of the transistor may be single-gate or double-gate, an active layer of the transistor may be polysilicon, amorphous silicon or oxide semiconductor material, and so on.

Exemplarily, in an embodiment of the present disclosure, the display panel includes a plurality of sub-pixels having different colors. For example, the display panel includes a red sub-pixel, a green sub-pixel, and a blue sub-pixel. In different states, the first data signals PAM_DATA corresponding to the sub-pixels 1 of a same color are different from each other. Based on such a configuration, the sub-pixels 1 of a same color can operate in different states to compensate for brightness differences caused by factors such as different light emitting moments or different threshold voltage drifts, so that the brightness of the sub-pixels of a same color tends to be consistent in a display period, thereby improving the display uniformity.

Exemplarily, in an embodiment of the present disclosure, first data signals PAM_DATA corresponding to at least two red sub-pixels are different from each other in different states; or, first data signals PAM_DATA corresponding to at least two green sub-pixels are different from each other in different states; or, first data signals PAM_DATA corresponding to at least two blue sub-pixels are different from each other in different states.

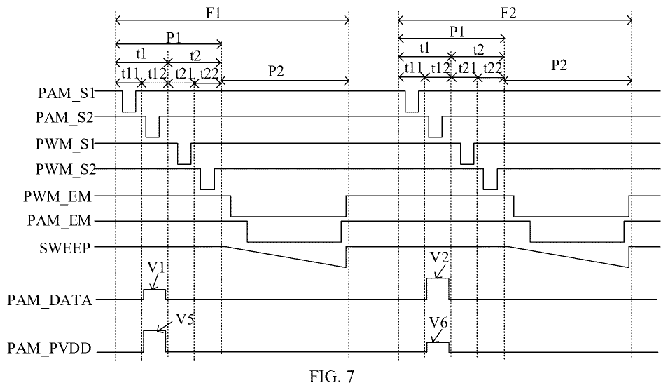

For example, the above-mentioned different states include a first state and a second state that are different. According to an embodiment of the present disclosure, in an optional implementation, a first data signal in the first state is different from a first data signal in the second state. For example, when the sub-pixel 1 is configured to the pixel driving circuit shown in FIG. 3, a same sub-pixel 1 receives different first data signals PAM_DATA in different periods, so that the sub-pixel 1 operates in the first state and the second state that are different from each other, thereby avoiding flicker caused by inconsistent brightness of the sub-pixel 1 over time, and improving the display effect. As shown in FIG. 7, which is an operation timing diagram of a sub-pixel at two different frame periods according to an embodiment of the present disclosure, a voltage value of the first data signal PAM_DATA received by the sub-pixel in a frame period F1 is V1, and a voltage value of the first data signal PAM_DATA received in another frame period F2 is V2, where V1≠V2.

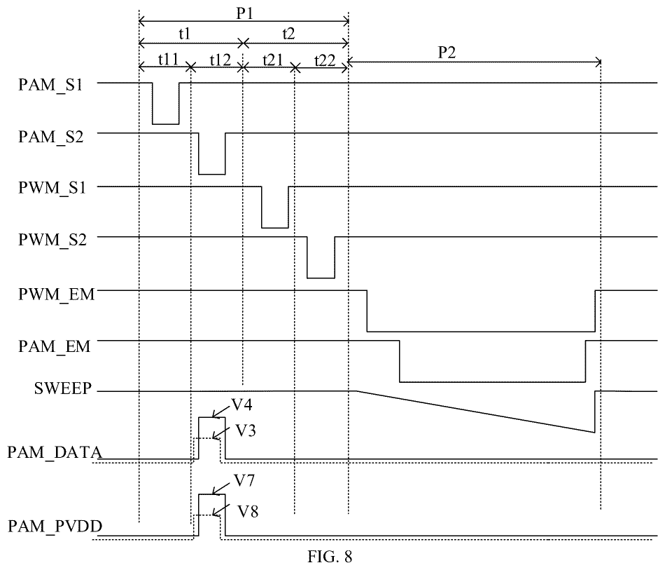

Alternatively, different sub-pixels 1 in different regions of the display panel receive different first data signals PAM_DATA, so that the sub-pixels 1 in at least two regions operate in the first state and the second state that are different from each other, thereby improving the brightness consistency of different regions of the display panel. As shown in FIG. 8, which is an operation timing diagram of two different sub-pixels according to an embodiment of the present disclosure, a voltage value of the first data signal PAM_DATA received by a sub-pixel is V3, and a voltage value of the first data signal PAM_DATA received by another sub-pixel is V4, where V3≠V4. FIG. 8 shows that the timings of the first pulse amplitude scanning signal PAM_S1, the second pulse amplitude scanning signal PAM_S2, the first pulse width scanning signal PWM_S1, the second pulse width scanning signal PWM_S2, the pulse amplitude light emitting control signal PAM_EM, the pulse width light emitting control signal PWM_EM and the swept-frequency signal SWEEP that are received by two different sub-pixels are the same. In FIG. 8, waveforms of the first data signals PAM_DATA received by the two different sub-pixels are distinguished by solid lines and dashed lines, and waveforms of the first power signals PAM_PVDD received by the two different sub-pixels are distinguished by solid lines and dashed lines.

Alternatively, in another optional implementation, the first power signal in the first state is different from the first power signal in the second state. For example, when the sub-pixel 1 is configured to the pixel driving circuit shown in FIG. 3, a same sub-pixel 1 receives different first power signals PAM_PVDD in different periods, so that the sub-pixel 1 operates in the first state and the second state that are different from each other, thereby avoiding flicker caused by inconsistent brightness of the sub-pixel 1 over time, and improving the display effect. As shown in FIG. 7, a voltage value of the first power signal PAM_PVDD received by the sub-pixel in one frame period F1 is V5, and a voltage value of the first power signal PAM_PVDD received by the sub-pixel in another frame period F2 is V6, where V5≠V6.

Alternatively, different sub-pixels 1 in different regions of the display panel receive different first power signals PAM_PVDD, so that the at least two sub-pixels 1 operate in the first state and the second state that are different from each other, thereby improving the brightness consistency of different regions of the display panel. As shown in FIG. 8, a voltage value of the first power signal PAM_PVDD received by a sub-pixel is V7, and a voltage value of the first power signal PAM_PVDD received by another sub-pixel is V8, where V7≠V8.

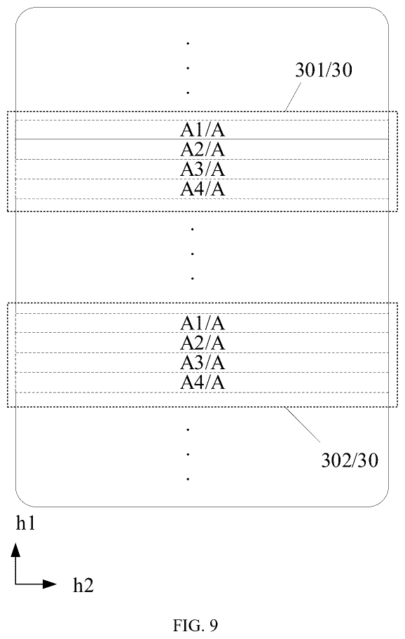

Exemplarily, as shown in FIG. 9, which is a schematic diagram of a display panel according to an embodiment of the present disclosure, the display panel includes a plurality of display sub-regions A. In an embodiment of the present disclosure, sub-pixels 1 in at least two different display sub-regions A receive different first data signals. Alternatively, the sub-pixels 1 in at least two different display sub-regions A receive different first power signals.

For example, the display sub-regions A at least include a first display sub-region A1 and a second display sub-region A2, and the sub-pixel 1 has the structure shown in FIG. 3. In an embodiment of the present disclosure, a first data signal PAM_DATA received by the sub-pixel 1 in the first display sub-region A1 is different from a first data signal PAM_DATA received by the sub-pixel 1 in the second display sub-region A2; alternatively, a first power signal PAM_PVDD received by the sub-pixel 1 in the first display sub-region A1 is different from a first power signal PAM_PVDD received by the sub-pixel 1 in the second display sub-region A2.

In an embodiment of the present disclosure, the display sub-regions A can be divided according to light emitting moments of different regions in the display panel. A plurality of sub-pixels in a same display sub-region A can emit light at a same moment, and sub-pixels located in different display sub-regions A can emit light at different moments. As shown in FIG. 9, the display panel includes a first display sub-region A1, a second display sub-region A2, a third display sub-region A3 and a fourth display sub-region A4, and sub-pixels in the first display sub-region A1, the second display sub-region A2, the third display sub-region A3 and the fourth display sub-region A4 emit light at different moments.

Exemplarily, in an embodiment of the present disclosure, as shown in FIG. 9, the display panel includes a plurality of display portions 30 repeatedly arranged along a first direction h1, and the display portion 30 includes a plurality of display sub-regions A that emit light at different moments as described above. As shown in FIG. 9, the display portions 30 at least include a first display portion 301 and a second display portion 302. The first display portion 301 includes a first display sub-region A1, a second display sub-region A2, a third display sub-region A3 and a fourth display sub-region A4. The second display portion 302 includes a first display sub-region A1, a second display sub-region A2, a third display sub-region A3 and a fourth display sub-region A4. A plurality of first display sub-regions Al can emit light at a same moment, a plurality of second display sub-regions A2 can emit light at a same moment, a plurality of third display sub-regions A3 can emit light at a same moment, and a plurality of fourth display sub-regions A3 can emit light at a same moment.

As shown in FIG. 9, two adjacent first display sub-regions A1 can be separated from each other by a second display sub-region A2, a third display sub-region A3, and a fourth display sub-region A4; and two adjacent second display sub-regions A2 can be separated from each other by a third display sub-region A3, a fourth display sub-region A4, and a first display sub-region A1, that is, the display sub-regions A that emit light at a same moment are separated from each other by different display sub-regions A that emit light at other moments. Based on such a configuration, the display sub-regions A that are emitting light are not concentrated in one region, but are distributed in at least two display portions 30, thereby further improving the uniformity of the display image.

In the embodiments of the present disclosure, the display region of the display panel is divided into multiple display sub-regions, and different display sub-regions A are lit up in a time-sharing manner, thereby avoiding a problem of excessive voltage drop caused by excessive load on the first power signal line when all sub-pixels 1 in the display panel are lit up at a same moment. The first power signal line is configured to transmit the first power signal PAM_PVDD. Based on such a configuration, the load on the first power signal line can be reduced, thereby reducing a voltage drop of the first power signal PAM_PVDD during the transmission process, and improving the display uniformity of the display panel.

Moreover, in the embodiments of the present disclosure, the first data signals received by the sub-pixels 1 in at least two different display sub-regions A are different from each other, or the first power signals received by the sub-pixels 1 in the at least two different display sub-regions A are different from each other, then when the display panel is driven, the sub-pixels 1 in the at least two different display sub-regions A can operate in different states. For example, the sub-pixels 1 in the first display sub-region Al can operate in one of the first state and the second state, and the sub-pixels 1 in the second display sub-region A2 can operate in the other one of the first state and the second state, so that the driving currents of the sub-pixels 1 in the at least two different display sub-regions Al can be configured differentially, thereby compensating for a problem of brightness non-uniformity caused by different light emitting moments of the sub-pixels 1 in the different display sub-regions A, and thus improving the brightness consistency of different regions of the display panel.

For example, in an embodiment of the present disclosure, each display sub-region A may include a single pixel row, or include a plurality of pixel rows 3 adjacently arranged in the first direction h1.

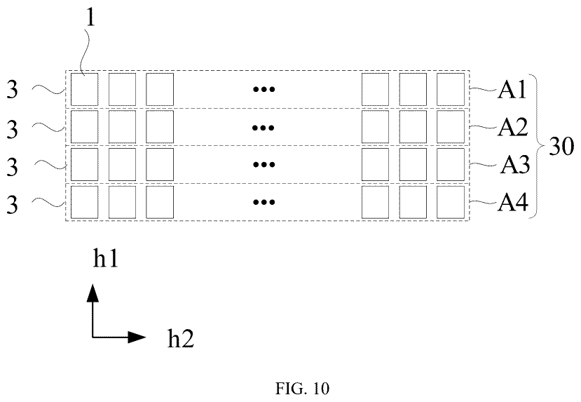

As shown in FIG. 10, which is a schematic diagram of a display portion according to an embodiment of the present disclosure, the display portion 30 includes a first display sub-region A1, a second display sub-region A2, a third display sub-region A3 and a fourth display sub-region A4, and each display sub-region includes a pixel row 3.

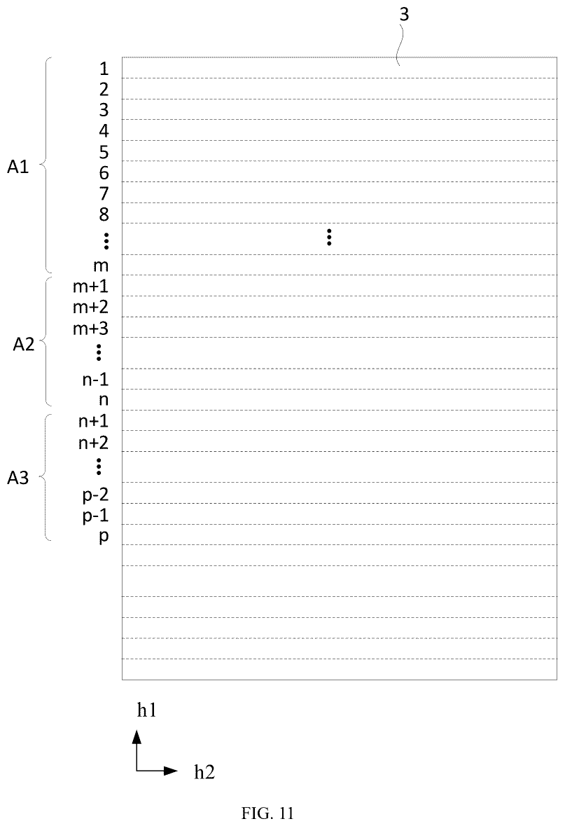

Alternatively, as shown in FIG. 11, FIG. 11 is a schematic diagram of another display panel according to an embodiment of the present disclosure. In an embodiment of the present disclosure, the first display sub-region A1 can include m pixel rows. For example, in an direction from top to bottom of the display panel, the first display sub-region A1 includes a first pixel row to an m-th pixel row, the second display sub-region A2 includes an (m+1)-th pixel row to an n-th pixel row, and the third display sub-region A3 includes an (n+1)-th pixel row to a p-th pixel row. M is an integer greater than or equal to 1, n is an integer greater than or equal to m, and p is an integer greater than or equal to n.

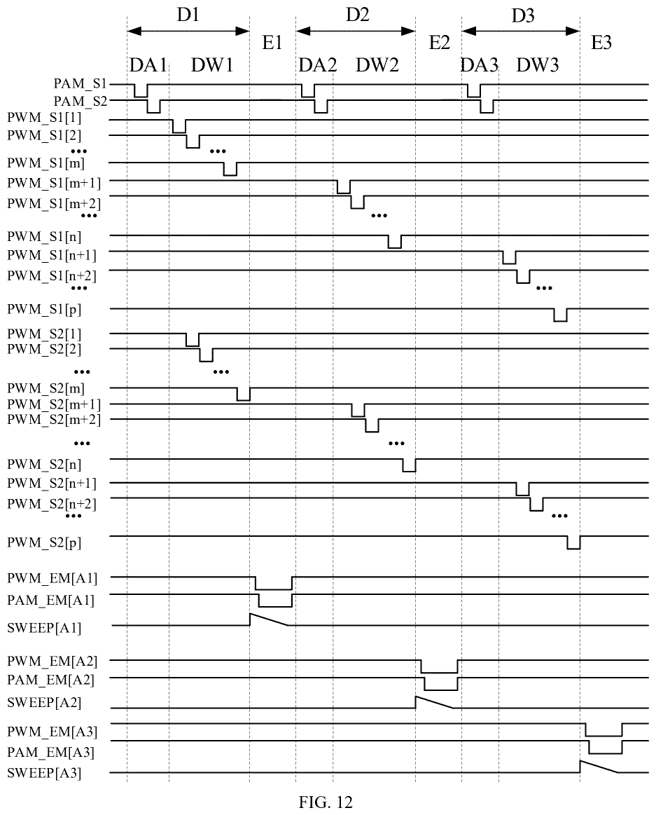

Exemplarily, with reference to FIG. 3 and FIG. 12, FIG. 12 is an operation timing diagram of a display panel according to an embodiment of the present disclosure, in an embodiment of the present disclosure, when the display panel is driven, different pixel rows 3 can receive a same first pulse amplitude scanning signal PAM_S1, and different pixel rows 3 can receive a same second pulse amplitude scanning signal PAM_S2, so as to simplify the driving timing of the display panel and reduce a number of the first pulse amplitude scanning signal PAM_S1 and the second pulse amplitude scanning signal PAM_S2 required for the operation of the display panel.

For example, in an embodiment of the present disclosure, the pixel rows 3 in a same display sub-region A can receive a same swept-frequency signal SWEEP, a same pulse width light emitting control signal PWM_EM, and a same pulse amplitude light emitting control signal PAM_EM, so that the pixel rows 3 in a same display sub-region A emit light simultaneously. Compared with a manner in which different pixel rows 3 receive different above-mentioned signals, the driving timing of the display panel can be simplified, and a number of the swept-frequency signal SWEEP, the pulse width light emitting control signal PWM_EM and the pulse amplitude light emitting control signal PAM_EM required for operation of the display panel can be reduced.

As shown in FIG. 12, when the display panel displays, a driving process of the display panel includes a first data writing phase D1 and a first light emitting phase E1 corresponding to the first display sub-region A1, a second data writing phase D2 and a second light emitting phase E2 corresponding to the second display sub-region A2, and a third data writing phase D3 and a third light emitting phase E3 corresponding to the third display sub-region A1.

The first data writing phase D1, the second data writing phase D2, and the third data writing phase D3 each include a first data signal writing phase DA and a second data signal writing phase DW. For distinguishing, in FIG. 12, the first data signal writing phase in the first data writing phase D1 is marked as DA1, the first data signal writing phase in the second data writing phase D2 is marked as DA2, and the first data signal writing phase in the third data writing phase D3 is marked as DA3; and, the second data signal writing phase in the first data writing phase D1 is marked as DW1, the second data signal writing phase in the second data writing phase D2 is marked as DW2, and the second data signal writing phase in the third data writing phase D3 is marked as DW3.

In the first data signal writing phase DA1, the first pulse amplitude scanning signal PAM_S1 and the second pulse amplitude scanning signal PAM_S2 sequentially provide an enable level. When the second pulse amplitude scanning signal PAM_S2 provides an enable level, the second data writing transistor M9 and the second compensation transistor M10 are turned on, and the first data signal PAM_DATA is written into the gate of the second driving transistor M7 through the second data writing transistor M9 and the second compensation transistor M10, and threshold compensation is performed.

In the second data signal writing phase DW1, the first pulse width scanning signal PWM_S1 and the second pulse width scanning signal PWM_S2 in the m sub-pixel rows in the first display sub-region A1 provide an enable level row by row. Then, the first light emitting phase E1 is entered. In the first light emitting phase E1, a pulse width light emitting control signal PWM_EM[A1] and a pulse amplitude light emitting control signal PAM_EM[A1] in the first display sub-region A1 provide an enable level, and the m sub-pixel rows in the first display sub-region A1 emit light. The driving current flowing through the sub-pixel is related to the respective received first data signal PAM_DATA and first power signal PAM_PVDD. The light emitting duration is related to the written second data signal PWM_DATA and swept-frequency signal SWEEP.

Then, the second data writing phase D2, the second light emitting phase E2, the third data writing phase D3 and the third light emitting phase are sequentially performed for driving, and the driving process in each phase is similar to the driving process in the corresponding phase of the first display sub-region A1. The difference from the first display sub-region A1 is that: in the first data signal writing phase DA2, the first data signal PAM DATA written to the sub-pixel in the second display sub-region A2 is different from the first data signal PAM_DATA written to the sub-pixel in the first display sub-region A1 in the first data signal writing phase DA1. In the first data signal writing phase DA3, the first data signal PAM_DATA written to the sub-pixel in the third display sub-region A3 is different from the first data signal PAM_DATA written to the sub-pixel in the first display sub-region A1 in the first data signal writing phase DA1, and is also different from the first data signal PAM DATA written to the sub-pixel in the second display sub-region A2 in the first data signal writing phase DA2.

In the embodiments of the present disclosure, by writing different first data signals PAM DATA to different display sub-regions A, compared with a situation in which a same first data signal is written to all display sub-regions, different first data signals PAM_DATA can be used to compensate the brightness variations in each display sub-region A caused by factors such as different light emitting moments, fluctuation in the driving signals, and drifts of threshold voltage characteristics of driving transistors, thereby improving the brightness consistency of each display sub-region A.

In FIG. 12, the “i” of the first pulse width scanning signal PWM_S1[i] and the second pulse width scanning signal PWM_S2[i] represents a serial number of the pixel row where the pixel driving circuit is located. The first pulse width scanning signal PWM_S1[i] of the pixel driving circuit in the i-th row can be the same as the second pulse width scanning signal PWM_S2[i_1] of the pixel driving circuit in the (i_1)-th row.

The “j” of the swept-frequency signal SWEEP[j], the pulse width light emitting control signal PWM_EM[j] and the pulse amplitude light emitting control signal PAM_EM[j] represents a serial number of the display sub-region where the pixel driving circuit is located. For example, the pixel driving circuit is located in the display sub-region A1, and the above-mentioned signal terminals of the pixel driving circuit are the swept-frequency signal SWEEP[A1], the pulse width light emitting control signal PWM_EM[A1] and the pulse amplitude light emitting control signal PAM_EM[A1], respectively. That is, the pixel driving circuits in a display sub-region share a same swept-frequency signal SWEEP, a same pulse width light emitting control signal PWM_EM, and a same pulse amplitude light emitting control signal PAM_EM, so that the sub-pixels in the same display sub-region emit light simultaneously.

For example, in an embodiment of the present disclosure, the sub-pixels in a same display sub-region A share a same first data signal PAM_DATA, herein, sharing means that the sub-pixels 1 in a same display sub-region A receive a same first data signal PAM_DATA. Based on such a configuration, the driving currents of the sub-pixels 1 in a same display sub-region A can be as consistent as possible, and the sub-pixels 1 in a same display sub-region can all operate in great uniformity and great efficiency. Moreover, when driving the display, a same first data signal PAM_DATA is provided to the sub-pixels 1 in a same display sub-region A, and the driving manner thereof is simpler.

For example, in an embodiment of the present disclosure, the sub-pixels 1 of a same color in a same display sub-region A share a first data signal PAM_DATA. Herein, sharing means that the sub-pixels 1 of same color in a same display sub-region A receive a same first data signal PAM_DATA. In an example, in an embodiment of the present disclosure, the sub-pixels 1 of a same color in a same display sub-region A can share a first data signal PAM_DATA under a same target grayscale, so that the driving currents of the sub-pixels 1 of a same color are as consistent as possible, and the sub-pixels 1 of a same color can all operate in a great uniformity and a great efficiency. Moreover, when driving the display, a same first data signal PAM_DATA is provided to the sub-pixels 1 of same color, and the driving manner thereof is simpler.

Exemplarily, in an embodiment of the present disclosure, under a same target grayscale, the sub-pixels 1 of different colors in a same display sub-region A may be driven adopting a same first data signal PAM_DATA, so that the driving currents of the sub-pixels 1 of different colors are as consistent as possible, and the sub-pixels 1 of different colors can all operate in a great uniformity and a great efficiency. Moreover, when driving the display, a same first data signal PAM_DATA is provided to the sub-pixels 1 of different colors, and the driving manner thereof is simpler.

Exemplarily, in an embodiment of the present disclosure, any two adjacent display sub-regions A correspond to different first data signals. Based on such a configuration, different display sub-regions A may adjust the received first data signals according to respective light emitting moments of the display sub-regions A, so that the driving currents of any two adjacent display sub-regions match the light emitting moments of the display sub-regions A, thereby adjusting the actual brightness of each display sub-region A more finely, and further improving the display consistency of the display panel.

For example, in an embodiment of the present disclosure, the first data signals PAM_DATA in any two display sub-regions A can be different from each other, to adjust display uniformity of different display sub-regions A.

In an optional implementation, according to a scanning sequence of the display sub-regions A, in an embodiment of the present disclosure, the first data signals PAM_DATA in different display sub-regions A can be gradually increased or gradually decreased. The scanning sequence is a time sequence in which the data writing phase is executed. For example, in FIG. 12, the display sub-regions are scanned in a sequence of the first display sub-region A1, the second display sub-region A2 and the third display sub-region A3. Therefore, according to the embodiments of the present disclosure, the first data signals PAM DATA received by the first display sub-region A1, the second display sub-region A2 and the third display sub-region A3 can be gradually increased or gradually decreased in sequence. Based on such a configuration, the influence of different scanning sequences on the actual brightness of each display sub-region A can be compensated, thereby further improving the display uniformity of the display panel.

In another optional implementation, according to an embodiment of the present disclosure, the first power signals PAM_PVDD of any two adjacent display sub-regions A can be different from each other. The first power signal PAM_PVDD can affect the driving current of the sub-pixel 1. Based on such a configuration, different display sub-regions A can adjust the received first power signals PAM_PVDD according to respective light emitting moments of the display sub-regions A, so that driving currents of any two adjacent display sub-regions A can match the light emitting moments of the display sub-regions A, thereby adjusting the actual brightness of each display sub-region A more finely, and further improving the display consistency of the display panel.

For example, in an embodiment of the present disclosure, the first power signals PAM_PVDD of any two display sub-regions A can be different from each other, to adjust display uniformity of different display sub-regions A.

Exemplarily, in an embodiment of the present disclosure, the first power signals PAM PVDD of different display sub-regions A can be gradually increased or gradually decreased according to a scanning sequence of the display sub-regions A. For example, in FIG. 12, the display sub-regions are scanned in an order of the first display sub-region A1, the second display sub-region A2 and the third display sub-region A3. Therefore, in an embodiment of the present disclosure, the first power signal PAM_PVDD received by the first display sub-region A1, the second display sub-region A2 and the third display sub-region A3 can be gradually increased or gradually decreased in sequence. Based on such a configuration, the influence of different scanning sequences on the actual brightness of each display sub-region A can be compensated, thereby further improving the display uniformity of the display panel.

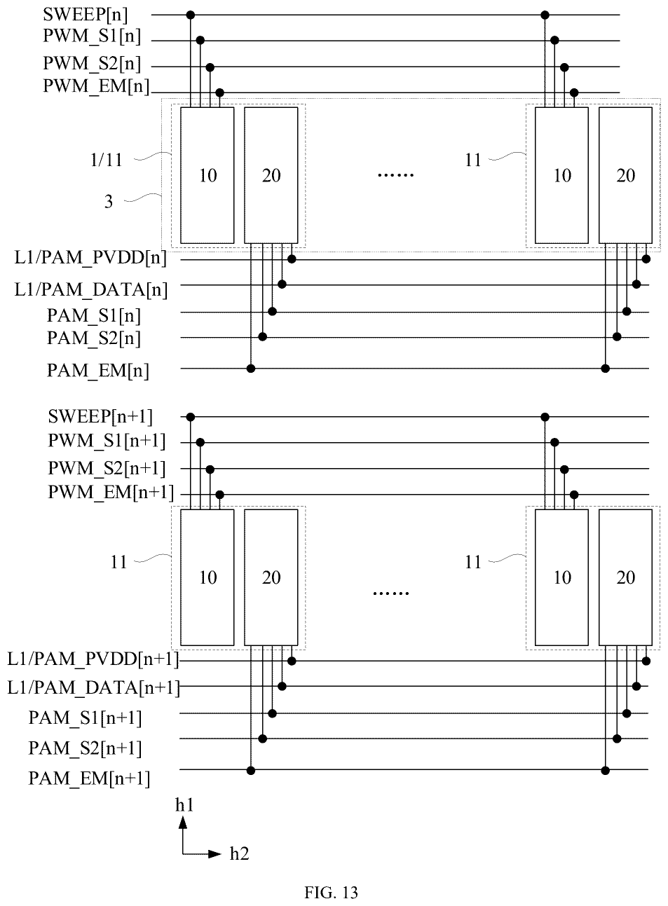

For example, as shown in FIG. 13, FIG. 13 is a schematic diagram of another display panel according to an embodiment of the present disclosure, the display panel includes pixel rows 3 arranged along a first direction h1, and one pixel row 3 includes sub-pixels 1 arranged along a second direction h2. The sub-pixel 1 includes a pixel driving circuit 11, and the pixel driving circuit 11 includes a pulse amplitude modulation module 20 and a pulse width modulation module 10 that are electrically connected to each other. The first direction hl intersects with the second direction h2, and FIG. 12 shows that the first direction h1 and the second direction h2 are perpendicular to each other.

As shown in FIG. 13, the display panel further includes a swept-frequency signal line SWEEP, a first pulse width scanning signal line PWM_S1, a second pulse width scanning signal line PWM_S2, a pulse width light emitting control signal line PWM_EM, a pulse amplitude light emitting control signal line PAM_EM, a first pulse amplitude scanning signal line PAM_S1, a second pulse amplitude scanning signal line PAM_S2, a first data signal line PAM_DATA, and a first power signal line PAM_PVDD arranged along the first direction h1 and each extending along the second direction h2. The swept-frequency signal line SWEEP is configured to provide a swept-frequency signal SWEEP to the pixel driving circuit 11 (the signal line and the signal it transmits are marked by a same reference sign for simplicity and clarity to show the relationship between the two herein). The first pulse width scanning signal line PWM_S1 is configured to provide a first pulse width scanning signal PWM_SI to the pixel driving circuit 11. The second pulse width scanning signal line PWM_S2 is configured to provide a second pulse width scanning signal PWM_S2 to the pixel driving circuit 11. The pulse width light emitting control signal line PWM_EM is configured to provide a pulse width light emitting control signal PWM_EM to the pixel driving circuit 11. The first pulse amplitude scanning signal line PAM_S1 is configured to provide a first pulse amplitude scanning signal PAM_S1 to the pixel driving circuit 11. The second pulse amplitude scanning signal line PAM_S2 is configured to provide a second pulse amplitude scanning signal PAM_S2 to the pixel driving circuit 11. The first data signal line PAM_DATA is configured to provide a first data signal PAM_DATA to the pixel driving circuit 11. The first power signal line PAM_PVDD is configured to provide a first power signal PAM_PVDD to the pixel driving circuit 11.

In an embodiment of the present disclosure, the display panel includes signal transmission lines L1 that are configured to transmit the first data signal PAM_DATA or the first power signal PAM_PVDD. In an embodiment of the present disclosure, a same pixel row 3 corresponds to a same signal transmission line L. That is, a same pixel row 3 receives a same first data signal PAM_DATA or a same first power signal PAM_PVDD through a same signal transmission line L.

For example, the signal transmission lines L1 include a first data signal line PAM DATA and/or a first power signal line PAM_PVDD. The first data signal line PAM DATA transmits the first data signal PAM_DATA. The first power signal line PAM PVDD transmits the first power signal PAM_PVDD. FIG. 13 shows an example that the display panel includes two signal transmission lines L1 corresponding to a pixel row 3, one of the two signal transmission lines L1 is a first data signal line PAM_DATA for transmitting a first data signal, and the other one of the two signal transmission lines L1 is a first power signal line PAM_PVDD for transmitting a first power signal.

Based on a such configuration, the first data signal line PAM_DATA can be configured to provide different first data signals PAM_DATA to at least two different pixel rows 3, or the first power signal line PAM_PVDD can be configured to provide different first power signals PAM_PVDD to at least two different pixel rows 3, so as to provide differentiated first data signals PAM_DATA or first power signals PAM_PVDD to the sub-pixels 1 in different regions, thereby improving the display uniformity of the display panel. In FIG. 13, the first data signal line PAM_DATA[n] provides a first data signal PAM_DATA to the n-th pixel row 3, and the first power signal line PAM_PVDD[n] provides a first power signal PAM_PVDD to the n-th pixel row 3. The first data signal line PAM_DATA [n+1] provides another first data signal PAM_DATA to the (n+1)-th pixel row 3, and the first power signal line PAM_PVDD[n] provides another first power signal PAM_PVDD to the (n+1)-th pixel row 3.

In an embodiment of the present disclosure, two adjacent pixel rows 3 correspond to different first data signals PAM_DATA; alternatively, two adjacent pixel rows 3 correspond to different first power signals PAM_PVDD.

For example, when the display region of the display panel is divided into display sub-regions, two adjacent pixel rows 3 can belong to a same display sub-region A.

When the display sub-region A includes pixel rows 3, based on such a configuration, the brightness of the sub-pixels in two adjacent pixel rows 3 in a same display sub-region A can be compensated differently to adjust the brightness of the display panel more finely, thereby further improving the brightness consistency of different pixel rows 3 in a same display sub-region A.

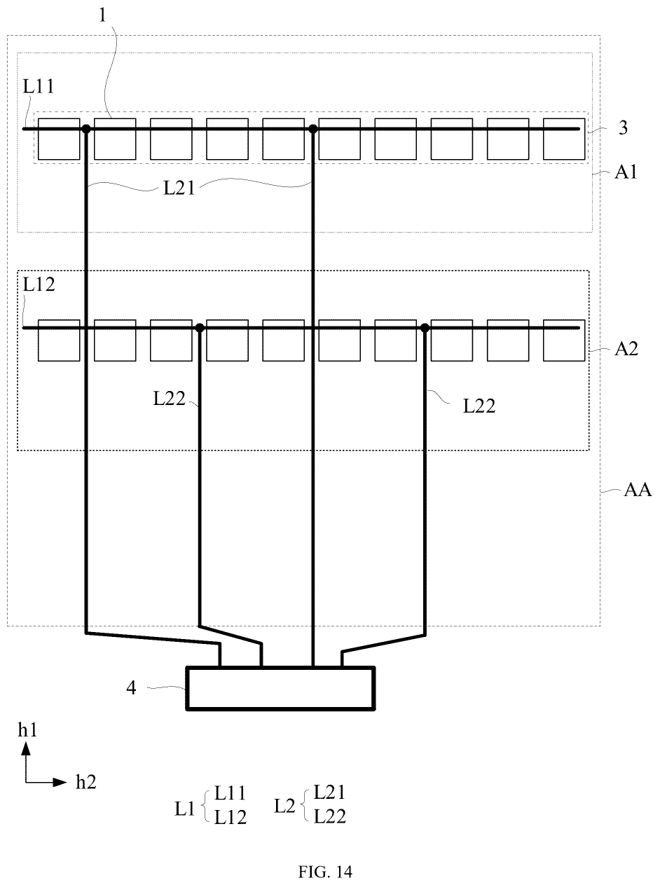

For example, as shown in FIG. 14, FIG. 14 is a schematic diagram of another display panel according to an embodiment of the present disclosure, in an embodiment of the present disclosure, the signal transmission lines L1 include a first signal transmission line L11 and a second signal transmission line L12. The first signal transmission line L11 and the second signal transmission line L12 are configured to provide signals to the sub-pixels 1 located in different display sub-regions A, so that the sub-pixels 1 located in different display sub-regions A have different states. In an embodiment of the present disclosure, in different states, a signal of the first signal transmission line L1 is different from a signal of the second signal transmission line L2.

In different states, a signal of the first signal transmission line L11 being different from a signal of the second signal transmission line L12 includes: the first signal transmission line L11 and the second signal transmission line L12 being electrically connected to a same sub-pixel 1, and transmitting different signals to the sub-pixel 1 in a time-sharing manner, so that the same sub-pixel 1 corresponds to different states in different periods.

Alternatively, the first signal transmission line L11 and the second signal transmission line L12 are electrically connected to the sub-pixels 1 in at least two different regions, for example, the first signal transmission line L11 is electrically connected to the sub-pixel 1 in the first display sub-region A1, and the second signal transmission line L12 is electrically connected to the sub-pixel 1 in the second display sub-region A2, so that the sub-pixels 1 in at least two different regions have different states.

For example, different states include a first state and a second state. In an embodiment of the present disclosure, the first signal transmission line L11 may be configured to transmit a signal to an x-th pixel row, so that the x-th pixel row has the first state. The second signal transmission line L12 may be configured to transmit a signal to the x-th pixel row in another period such that the x-th pixel row has the second state in another period. For example, in this case, the first signal transmission line L11 and the second signal transmission line L12 may be combined to be one signal transmission line that can provide different signals to the sub-pixels in different periods.

Alternatively, the first signal transmission line L11 is configured to transmit a signal to the x-th pixel row, so that the x-th pixel row has the first state; and the second signal transmission line L12 is configured to transmit a signal to a y-th pixel row that is different from the x-th pixel row, so that the y-th pixel row has the second state, where x≠y and x and y are both positive integers.

It should be noted that, in an embodiment of the present disclosure, the first signal transmission line L11 and the second signal transmission line L12 transmit signals having a same function. For example, the first signal transmission line L11 and the second signal transmission line L12 each transmit a first data signal PAM_DATA, or the first signal transmission line L11 and the second signal transmission line L12 each transmit a first power signal PAM_PVDD. In order to describe the embodiments of the present disclosure more clearly, a first signal transmission line for transmitting the first data signal PAM_DATA is named as a first A data signal line PAM_DATA1, and a first signal transmission line for transmitting the first power signal PAM_PVDD is named as a first A power signal line PAM_PVDD1. A second signal transmission line for transmitting the first data signal PAM_DATA is named as a second A data signal line PAM_DATA2, and a second signal transmission line for transmitting the first power signal PAM_PVDD is named as a second A power signal line PAM_PVDD2.

In different states, signals transmitted by the first A data signal line PAM_DATA1 and the second A data signal line PAM_DATA2 have a same function, that is, each are the first data signal PAM_DATA, but having different values. The signals transmitted by the first A power signal line PAM_PVDD1 and the second A power signal line PAM_PVDD2 have a same function, that is, each are the first power signal PAM_PVDD, but having different values.

For example, as shown in FIG. 14, the display panel includes a driving circuit 4 that is located at a side of the display area AA along the first direction h1, and the driving circuit 4 is electrically connected to the signal transmission line L1. The driving circuit 4 is configured to provide the first data signal PAM_DATA or the first power signal PAM_PVDD.

In an embodiment of the present disclosure, the display panel further includes a connection portion L2 electrically connected to the signal transmission line L1. The signal transmission line L1 extends along the second direction h2, and the connection portion L2 extends along the first direction h1. The signal transmission line L1 is electrically connected to the pixel row 3 in the display sub-region A, and the connection portion L2 is electrically connected to the signal transmission line L1 and the driving circuit 4.

FIG. 14 takes the display panel including the first display sub-region A1 and the second display sub-region A2 as an example. Accordingly, the signal transmission lines L1 include a first signal transmission line L11 corresponding to the first display sub-region A1 and a second signal transmission line L12 corresponding to the second display sub-region A2. The connection portion L2 includes a first connection portion L21 electrically connected to the first signal transmission line L11 and a second connection portion L22 electrically connected to the second signal transmission line L12. The first signal transmission line L11 and the second signal transmission line L12 extend along the second direction h2, and the first connection portion L21 and the second connection portion L22 extend along the first direction h1. The first signal transmission line L11 is electrically connected to a plurality of sub-pixels 1 in the first display sub-region A1, and the second signal transmission line L12 is electrically connected to a plurality of sub-pixels 1 in the second display sub-region A2. The first connection portion L21 electrically connects the first signal transmission line L11 and the driving circuit 4, and the second connection portion L22 electrically connects the second signal transmission line L12 and the driving circuit 4.

For example, the signal transmission line L1 can be electrically connected to the driving circuit 4 through at least two connection portions L2. As shown in FIG. 14, the first signal transmission line L11 is electrically connected to the driving circuit 4 through two first connection portions L21, and the second signal transmission line L12 is electrically connected to the corresponding driving circuit 4 through two second connection portions L22. Based on such a configuration, a transmission rate of a corresponding signal can be increased, and a voltage drop during a signal transmission process can be reduced.

In an embodiment of the present disclosure, the display panel further includes scanning signal lines. An extending direction of the scanning signal line is parallel to an extending direction of the signal transmission line L1. As shown in FIG. 13, the scanning signal lines include any one or more of the first pulse width scanning signal line PWM_S1, the second pulse width scanning signal line PWM_S2, the pulse width light emitting control signal line PWM_EM, the pulse amplitude light emitting control signal line PAM_EM, the first pulse amplitude scanning signal line PAM_S1, and the second pulse amplitude scanning signal line PAM_S2.

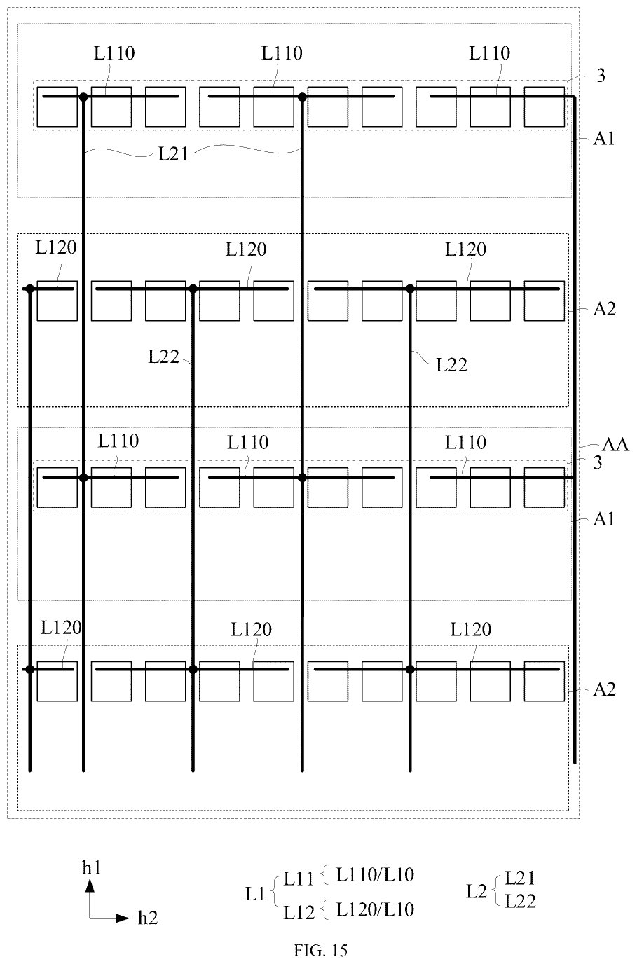

For example, as shown in FIG. 15, FIG. 15 is a schematic diagram of another display panel according to an embodiment of the present disclosure, in an embodiment of the present disclosure, the signal transmission line L1 can be configured to include signal transmission sub-lines L10 arranged along the second direction h2, and two adjacent signal transmission sub-lines L10 are spaced from each other. The signal transmission sub-line L10 is electrically connected to the connection portion L2. Exemplarily, one signal transmission sub-line L10 is electrically connected to at least one connection portion L2. In an embodiment of the present disclosure, the connection portion L2 corresponding to one of the display sub-regions A is located between two adjacent signal transmission sub-lines L10 corresponding to another display sub-region A, thereby avoiding a cross-line design of the connection portion L2 corresponding to one of the display sub-regions A and the signal transmission line L1 located in the another display sub-region A, and thus reducing an coupling capacitance between the two.

When the display panel is configured to include the first display sub-region A1 and the second display sub-region A2, as shown in FIG. 15, the first signal transmission line L11 corresponding to the first display sub-region A1 includes a plurality of first signal transmission sub-lines L110 arranged along the second direction h2, and two adjacent first signal transmission sub-lines L110 are spaced from each other. The first signal transmission sub-line L110 is electrically connected to the first connection portion L21. For example, one first signal transmission sub-line L110 is electrically connected to at least one first connection portion L21.

The second signal transmission line L21 corresponding to the second display sub-region A2 includes a plurality of second signal transmission sub-lines L120 arranged along the second direction h2, and two adjacent second signal transmission sub-lines L120 are spaced from each other. The second signal transmission sub-line L120 is electrically connected to the second connection portion L22. Exemplarily, one second signal transmission sub-line L120 is electrically connected to at least one second connection portion L22.

As shown in FIG. 14, the second connection portion L22 is at least partially located between two adjacent first signal transmission sub-lines L110. Based on such a configuration, the first signal transmission line L11 and the second connection portion L22 can be prevented from crossing each other, thereby avoiding crossing lines of the first signal transmission line L11 and the second connection portion L22, and thus reducing the coupling capacitance between the two.

As shown in FIG. 14, the first connection portion L21 is at least partially located between two adjacent second signal transmission sub-lines L120. Based on such a configuration, the second signal transmission line L21 and the first connection portion L12 can be prevented from crossing each other, thereby avoiding crossing lines of the second signal transmission line L21 and the first connection portion L12, and thus reducing the coupling capacitance between the two.

Exemplarily, as shown in FIG. 14, the first signal transmission sub-line L110 and the second signal transmission sub-line L120 are at least partially staggered in the first direction h1.

For example, in an embodiment of the present disclosure, the signal transmission sub-line L10 and the connection portion L2 can be arranged in a same layer. For example, at least two of the first signal transmission sub-line L110, the second signal transmission sub-line L120, the first connection portion L21 and the second connection portion L22 can be arranged in a same layer. Based on such a configuration, a manufacturing process of the display panel can be simplified, and a thickness of the display panel can be reduced.

For example, when driving the display panel, in an optional implementation, the brightness of the sub-pixels in two different regions can be compared first. The brightness is the actual brightness of the sub-pixel. The actual brightness can be detected by a brightness detection instrument. In an embodiment of the present disclosure, when the brightness of the sub-pixel in a region is smaller than the brightness of the sub-pixel in another region, a first data signal received by the sub-pixel in a region can be smaller than a first data signal received by the sub-pixel in another region, so as to increase the light emitting intensity of the sub-pixel in a region and reduce the light emitting intensity of the sub-pixel in another region, thereby reducing the actual brightness difference between the two after adjustment. For example, the actual brightness of the two regions after adjustment is the same, thereby improving the display uniformity of the display panel.

Alternatively, in an embodiment of the present disclosure, the first power signal received by the sub-pixel in a region can be greater than the first power signal received by the sub-pixel in another region, so as to increase the light emitting intensity of the sub-pixel in a region and reduce the light emitting intensity of the sub-pixel in another region, thereby reducing the actual brightness difference between the two after adjustment. For example, the actual brightness of the two regions after adjustment is the same, thereby improving the display uniformity of the display panel.

For example, the display panel includes the first display sub-region A1 and the second display sub-region A2 as shown in FIG. 9. When driving the display panel, in an embodiment of the present disclosure, the initial brightness of the sub-pixels in the first display sub-region A1 and the second display sub-region A2 can be compared first. Exemplarily, the initial brightness of the sub-pixels in the first display sub-region A1 and the second display sub-region A2 can be the brightness of the two at a same first initial data signal. Alternatively, the initial brightness of the sub-pixels in the first display sub-region A1 and the second display sub-region A2 may be the brightness of the two at a same first initial power signal.

When the initial brightness of the sub-pixel in the first display sub-region A1 is smaller than the initial brightness of the sub-pixel in the second display sub-region A2. In an embodiment of the present disclosure, the first data signal or the first power signal received by the first display sub-region A1 and the second display sub-region A2 can be adjusted, so that the first data signal received by the sub-pixel in the first display sub-region A1 is smaller than the first data signal received by the sub-pixel in the second display sub-region A2; or, the first power signal received by the sub-pixel in the first display sub-region A1 is greater than the first power signal received by the sub-pixel in the second display sub-region A2, so as to increase the light emitting intensity of the sub-pixel in the first display sub-region A1 and reduce the light emitting intensity of the sub-pixel in the second display sub-region A2, thereby reducing the actual brightness difference between the two after adjustment. For example, the actual brightness of the sub-pixel in the first display sub-region A1 and the actual brightness of the second display sub-region A2 after adjustment tend to be consistent.

For example, as shown in FIG. 8, in an embodiment of the present disclosure, a waveform of the first data signal PAM_DATA indicated by a dashed line represents the first data signal PAM_DATA received by the sub-pixel in the first display sub-region A1, and a waveform of the first data signal PAM_DATA indicated by a solid line represents the first data signal PAM_DATA received by the sub-pixel in the second display sub-region A2. As shown in FIG. 8, in an embodiment of the present disclosure, the first data signal PAM_DATA received by the sub-pixel in the first display sub-region A1 can be smaller than the first data signal PAM_DATA received by the sub-pixel in the second display sub-region A2, that is, V3<V4.

Alternatively, as shown in FIG. 8, in an embodiment of the present disclosure, a waveform of the first power signal PAM_PVDD indicated by a solid line represents the first power signal PAM_PVDD received by the sub-pixel in the first display sub-region A1, and a waveform of the first power signal PAM_PVDD indicated by a dashed line represents the first power signal PAM_PVDD received by the sub-pixel in the second display sub-region A2. As shown in FIG. 8, in an embodiment of the present disclosure, the first power signal PAM_PVDD received by the sub-pixel in the first display sub-region A1 can be greater than the first power signal PAM_PVDD received by the sub-pixel in the second display sub-region A2, that is, V7>V8.

Exemplarily, in an embodiment of the present disclosure, the target brightness of the sub-pixels in two different regions is the same. The target brightness is an ideal brightness that the sub-pixels in the two regions are expected to achieve. When the target brightness of the sub-pixels in the two different regions is the same, the influence of factors such as different light emitting moments or threshold voltage drifts on the actual light emitting brightness can be compensated in the above-described manner, and the difference in the actual brightness of the sub-pixels in the two different regions is reduced, thereby improving the display effect and avoiding the display non-uniformity.

In another optional implementation, in an embodiment of the present disclosure, the brightness of a same sub-pixel in two different periods may be compared first. When the sub-pixel in two different periods have different brightness, for example, in an embodiment of the present disclosure, when the brightness of the sub-pixel in one of the periods is smaller than the brightness of the sub-pixel in the other one of the periods, the first data signal received by the sub-pixel in one of the periods can be smaller than the first data signal received in the other one of the periods; alternatively, in an embodiment of the present disclosure, the first power signal received by the sub-pixel in one of the periods is greater than the first power signal received in the other one of the periods, so that the actual brightness difference between the two is reduced.

For example, two different periods include two different frame periods. With reference to FIG. 7, in an embodiment of the present disclosure, when the brightness of the sub-pixel in a frame period F1 is smaller than the brightness of the sub-pixel in another frame period F2, a first data signal PAM_DATA received by the sub-pixel in the frame period F1 is smaller than a first data signal PAM_DATA received by the sub-pixel in the frame period F2, that is, V1<V2. Alternatively, as shown in FIG. 7, in an embodiment of the present disclosure, the first power signal PAM_PVDD received by the sub-pixel in the frame period F1 is smaller than the first power signal PAM_PVDD received by the sub-pixel in the frame period F2, that is, V5>V6.

Exemplarily, in an embodiment of the present disclosure, the target brightness of the sub-pixel in the two periods is the same. The target brightness is an ideal brightness that the sub-pixel in the two periods is expected to achieve. When the target brightness of the sub-pixel in the two different periods is the same, the influence of factors such as different light emitting moments or different threshold voltage drifts on the actual light emitting brightness can be compensated in the above-described manner, and the difference in the actual brightness of the sub-pixel in the two different periods is reduced, thereby improving the display effect and avoiding the display non-uniformity.

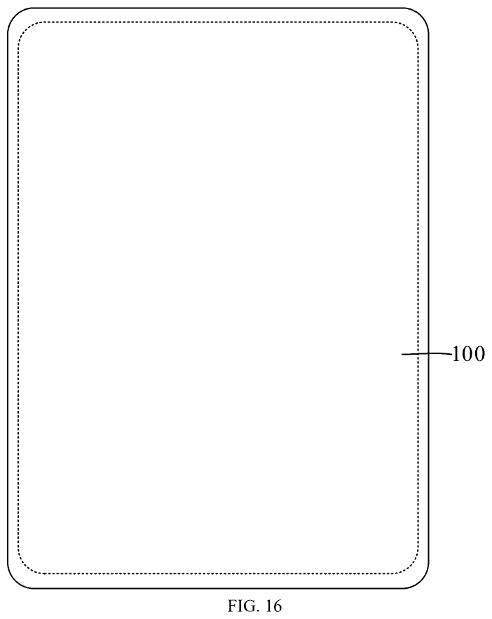

Based on a same inventive concept, an embodiment of the present disclosure further provides a display device, as shown in FIG. 16, which is a schematic diagram of a display device according to an embodiment of the present disclosure. The display device includes the above-mentioned display panel 100. The specific structure of the display panel 100 has been described in detail in the foregoing embodiments, and details are not described herein again. It is understandable that, the display device shown in FIG. 16 is merely illustrative, and the display device can be any electronic device having a display function, such as a mobile phone, a vehicle-mounted display screen, a tablet computer, a notebook computer, an electronic paper book, or a television.

Based on a same inventive concept, an embodiment of the present disclosure further provides a driving method of a display panel, applied to the above-mentioned display panel, and the driving method includes: controlling the sub-pixels to have different states. The different states include different light emitting intensities of the sub-pixels, or different first data signals received by the sub-pixels; or different first power signals received by the sub-pixels.

The sub-pixels having different states includes: a same one of the sub-pixels having different states in different periods, or the sub-pixels in at least two different regions having different states.

In the embodiments of the present disclosure, the sub-pixels have different states, that is, the light emitting intensities of the sub-pixels are different from each other or the first data signals received by the sub-pixels are different from each other, or the first power signals received by the sub-pixels are different from each other, so that a brightness difference caused by factors such as different light emitting moments of the sub-pixels or different threshold voltage drifts can be compensated, thereby improving the display consistency of the display panel in the different states, and improving the display effect of the display panel.

Exemplarily, target grayscales in the above-mentioned different states are the same. That is, the above-mentioned different states refer to different states under a common reference standard at a same target grayscale.

For example, the driving method of the display panel further includes: comparing brightness of the sub-pixels in two different regions; and when the brightness of the sub-pixel in one region is smaller than the brightness of the sub-pixel in another region, making a first data signal received by the sub-pixel in one region smaller than a first data signal received by the sub-pixel in the other region, or making a first power signal received by the sub-pixel in one region greater than a first power signal received by the sub-pixel in the other region.

With such a configuration, the light emitting intensity of the sub-pixel in one region can be increased, and the light emitting intensity of the sub-pixel in another region can be reduced, thereby reducing an actual brightness difference between the two after adjustment. For example, the actual brightness of the two regions after adjustment is equal.

Exemplarily, in an embodiment of the present disclosure, the target brightness of the sub-pixels in two different regions is the same. When the target brightness of the sub-pixels in the two different regions is the same, the influence of factors such as different light emitting moments or different threshold voltage drifts on the actual light emitting brightness can be compensated in the above-described manner, and a difference in the actual brightness of the sub-pixels in the two different regions is reduced, thereby improving the display effect and avoiding the display non-uniformity.

Exemplarily, the driving method of the display panel further includes: comparing brightness of the sub-pixel in two different periods; and when the brightness of the sub-pixel in one period is smaller than the brightness of the sub-pixel in the other period, making a first data signal received by the sub-pixel in one period smaller than a first data signal received by the sub-pixel in another period, or making a first power signal received by the sub-pixel in one period greater than a first power signal received by the sub-pixel in the other period.

With such a configuration, the light emitting intensity of the sub-pixels in one period can be increased, and the light emitting intensity of the sub-pixels in another period can be reduced, thereby reducing an actual brightness difference between the two after adjustment. For example, the actual brightness of the two periods after adjustment is equal.

Exemplarily, the brightness includes an actual brightness of the sub-pixel.

Exemplarily, in an embodiment of the present disclosure, the target brightness of the sub-pixels in the two different periods is the same. When the target brightness of the sub-pixels in two different periods is the same, the influence of factors such as different light emitting moments or different threshold voltage drifts on the actual light emitting brightness can be compensated in the above-described manner, and a difference in the actual brightness of the sub-pixels in two different periods is reduced, thereby improving the display effect and avoiding the display abnormality such as flicker.

The above description merely illustrates some preferred embodiments of the present disclosure and is not intended to limit the present disclosure, and any modification, equivalent substitution, improvement and the like made within a spirit and a principle of the present disclosure shall fall with a scope of the present disclosure.

Finally, it should be noted that, the above-described embodiments are merely for illustrating the present disclosure but not intended to provide any limitation. Although the present disclosure has been described in detail with reference to the above-described embodiments, it should be understood by those skilled in the art that, it is still possible to modify the technical solutions described in the above embodiments or to equivalently replace some or all of the technical features therein, but these modifications or replacements do not cause the essence of corresponding technical solutions to depart from the scope of the present disclosure.

What is claimed is:

1. A display panel, comprising sub-pixels having different states, wherein
the different states comprise different light emitting intensities of the sub-pixels, or different first data signals received by the sub-pixels, or different first power signals received by the sub-pixels; and
wherein the sub-pixels having different states comprise following cases: a same one of the sub-pixels corresponds to different states in different periods; or the sub-pixels in at least two different regions have different states.

2. The display panel according to claim 1, wherein
the different states comprise a first state and a second state that are different from each other, and the first state and the second state have a same target grayscale.

3. The display panel according to claim 1, wherein
one of the sub-pixels comprises a pulse amplitude modulation module corresponding to the first data signal, and a pulse width modulation module corresponding to a second data signal; and
at different states, at least two sub-pixels correspond to the different first data signals, and correspond to a same second data signal.

4. The display panel according to claim 1, wherein
at different states, at least two sub-pixels of a same color correspond to the different first data signals.

5. The display panel according to claim 1, wherein
the different states comprise a first state and a second state that are different from each other, and the first data signal at the first state is different from the first data signal at the second state, or the first power signal at the first state is different from the first power signal at the second state.

6. The display panel according to claim 5, wherein
one of the sub-pixels comprises a pixel driving circuit and a light emitting element that are electrically connected to each other;
the pixel driving circuit comprises a pulse width modulation module, a pulse amplitude modulation module and a driving transistor;
the pulse width modulation module is configured to output a pulse width setting signal to a first terminal of the pulse amplitude modulation module based on a swept-frequency signal;
the driving transistor is configured to output a driving current in response to a signal of a gate of the driving transistor and a signal of a first terminal of the driving transistor; and
the pulse amplitude modulation module is configured to control the light emitting element to emit light in response to the driving current based on the first data signal and the first power signal, and configured to output the pulse width setting signal to the gate of the driving transistor to control light emitting time of the light emitting element.

7. The display panel according to claim 1, comprising display sub-regions, wherein
the display sub-regions at least comprise a first display sub-region and a second display sub-region; and
the first data signal received by a sub-pixel in the first display sub-region is different from the first data signal received by a sub-pixel in the second display sub-region; or the first power signal received by the sub-pixel in the first display sub-region is different from the first power signal received by the sub-pixel in the second display sub-region.

8. The display panel according to claim 7, wherein
sub-pixels of a same color in a same display sub-region share a same one first data signal.

9. The display panel according to claim 7, wherein
any two adjacent display sub-regions correspond to the different first data signals.

10. The display panel according to claim 9, wherein
first data signals in different display sub-regions gradually increase or gradually decrease according to a scanning sequence of the display sub-regions.

11. The display panel according to claim 7, wherein
any two adjacent display sub-regions correspond to the different first power signals.

12. The display panel according to claim 11, wherein
the first power signals in different display sub-regions gradually increase or gradually decrease according to a scanning sequence of the display sub-regions.

13. The display panel according to claim 7, comprising signal transmission lines and pixel rows arranged along a first direction, wherein
one pixel row of the pixel rows comprises sub-pixels arranged along a second direction; and the signal transmission lines are configured to transmit the first data signals or the first power signals; and
one pixel row of the pixel rows corresponds to a respective one of the signal transmission lines.

14. The display panel according to claim 13, wherein
two adjacent pixel rows correspond to the different first data signals; or
two adjacent pixel rows correspond to the different first power signals.

15. The display panel according to claim 13, wherein
the signal transmission lines comprise a first signal transmission line and a second signal transmission line,
at different states, a signal of the first signal transmission line is different from a signal of the second signal transmission line;
the first display sub-region and the second display sub-region are arranged along the first direction; and the first display sub-region and the second display sub-region are provided with the sub-pixels arranged along the second direction;
the display panel further comprises a first connection portion electrically connected to the first signal transmission line, the first signal transmission line extends along the second direction, and the first connection portion extends along the first direction; and the first signal transmission line is electrically connected to sub-pixels in the first display sub-region, and the first connection portion is electrically connected to the first signal transmission line and a data driving circuit; and
the display panel further comprises a second connection portion electrically connected to the second signal transmission line, the second signal transmission line extends along the second direction, and the second connection portion extends along the first direction; and the second signal transmission line is electrically connected to sub-pixels in the second display sub-region, and the second connection portion is electrically connected to the second signal transmission line and the data driving circuit.

16. The display panel according to claim 15, wherein
the first signal transmission line comprises first signal transmission sub-lines arranged along the second direction, and two adjacent first signal transmission sub-lines are spaced from each other; and
the second connection portion is at least partially arranged between two adjacent first signal transmission sub-lines.

17. The display panel according to claim 16, wherein
at least two of the first signal transmission sub-line, the first connection portion and the second connection portion are arranged in a same layer.

18. The display panel according to claim 15, further comprising scanning signal lines, wherein
an extending direction of one of the scanning signal lines is parallel to an extending direction of the first signal transmission line and an extending direction of the second signal transmission line.

19. The display panel according to claim 1, wherein for two different regions, a brightness of the sub-pixel in one region is compared with a brightness of the sub-pixel in another one region, and upon determining that the brightness of the sub-pixel in one region is smaller than the brightness of the sub-pixel in another one region, the first data signal received by the sub-pixel in one region is smaller than the first data signal received by the sub-pixels in another one region, or the first power signal received by the sub-pixel in one region is greater than the first power signal received by the sub-pixel in another one region.

20. The display panel according to claim 19, wherein the sub-pixels in the two different regions have a same target brightness.

21. The display panel according to claim 1, wherein for two different periods, a brightness of the sub-pixel in one period is compared with a brightness of the sub-pixel in another one period, and upon determining that the brightness of the sub-pixel in one period is smaller than the brightness of the sub-pixel in another one period, the first data signal received by the sub-pixel in one period is smaller than the first data signal received by the sub-pixel in another one period, or the first power signal received by the sub-pixel in one period is greater than the first power signal received by the sub-pixel in another one period.

22. The display panel according to claim 21, wherein the sub-pixel in the two different periods has a same target brightness.

23. A display device, comprising a display panel comprising sub-pixels having different states, wherein
the different states comprise different light emitting intensities of the sub-pixels, or different first data signals received by the sub-pixels; or different first power signals received by the sub-pixels, and
wherein the sub-pixels having different states comprise following cases: a same one of the sub-pixels corresponds to different states in different periods; or the sub-pixels in at least two different regions have different states.

24. A driving method of a display panel, wherein
the display panel comprises sub-pixels having different states;
the different states comprise different light emitting intensities of the sub-pixels, or different first data signals received by the sub-pixels; or different first power signals received by the sub-pixels, and
wherein the sub-pixels having different states comprise following cases: a same one of the sub-pixels corresponds to different states in different periods; or the sub-pixels in at least two different regions have different states,
wherein the driving method comprises: controlling the sub-pixels to have different states.

25. The driving method according to claim 24, comprising:
for two different regions, comparing a brightness of the sub-pixel in one region with a brightness of the sub-pixel in another one region, and
upon determining that the brightness of the sub-pixel in one region is smaller than the brightness of the sub-pixel in another one region, making the first data signal received by the sub-pixel in one region be smaller than the first data signal received by the sub-pixels in another one region, or making the first power signal received by the sub-pixel in one region be greater than the first power signal received by the sub-pixel in another one region

26. The driving method according to claim 25, wherein the sub-pixels in the two different regions have a same target brightness.

27. The driving method according to claim 24, comprising:
for two different periods, comprising a brightness of the sub-pixel in one period with a brightness of the sub-pixel in another one period; and
upon determining that the brightness of the sub-pixel in one period is smaller than the brightness of the sub-pixel in another one period, the first data signal received by the sub-pixel in one period is smaller than the first data signal received by the sub-pixel in another one period, or the first power signal received by the sub-pixel in one period is greater than the first power signal received by the sub-pixel in another one period

28. The driving method according to claim 27, wherein the sub-pixel in the two different periods has a same target brightness.
